(19) United States
(12) Patent Application Publication
(10) Pub. No.: US 2010/0194686 A1
(43) Pub. Date: Aug. 5, 2010

(54) DISPLAY CONTROL METHOD, MOBILE TERMINAL OF USING THE SAME AND RECORDING MEDIUM THEREOF

(75) Inventor: Jae Bum Shim, Seoul (KR)

Correspondence Address: LRK Patent Law Firm, 1952 Gallows Rd, Suite 200, Vienna, VA, 22182, US

(73) Assignee: LOGICPLANT, Seoul (KR)

(21) Appl. No.: 12/669,484

(22) PCT Filed: Jul. 11, 2008
(86) PCT No.: PCT/KR08/04108

§ 371 Date: Jan. 16, 2010

(30) Foreign Application Priority Data
Aug. 2, 2007 (KR) 10-2007-0077907

(51) Int. Cl. G09G 5/08

(52) U.S. Cl. 345/157

(57) ABSTRACT

The present invention relates to a display control method and a mobile terminal using the method, which can promptly move a pointing cursor between entities, and can easily move the pointing cursor to an arbitrary location on the screen. The display control method according to the present invention displays a user interface and a pointing cursor, if a movement key for moving the pointing cursor is pressed for a period of time greater than a preset period of time, the indication location of the pointing cursor is moved to correspond to the manipulation direction of the movement key. In contrast, if the movement key is pressed for a period of time equal to or less than the preset period of time, the indication location of the pointing cursor is moved to an entity close to the pointing cursor in the manipulation direction of the movement key.

### TECHNICAL FIELD

The present invention relates, in general, to a display control method and a mobile terminal using the method, which can easily perform the prompt movement of a pointing cursor between entities and the movement of the pointing cursor to an arbitrary location on a screen in a user interface for displaying entities, which interact with a user, on the screen.

### BACKGROUND ART

In a user interface provided in a device, which does not support an input scheme, such as a touch pad, capable of easily designating an absolute location on a screen, among various mobile terminals such as a mobile phone, it is general that the movement between entities, which interact with a user, for example, between menu items or selection buttons, is supported only through the use of direction keys or corresponding keys, without indicating a pointing cursor, as is the case for a conventional PC which did not support a mouse.

However, in software, such as a full browser, which has been emphasized in mobile terminals and which is characterized in that the same screen as that of a PC is also displayed on a mobile terminal, there may be the case where a PC user interface, manufactured on the premise that a mouse is present, must be used in the same way by the device which has no mouse.

In this case, in order for a user to conveniently select a desired interacting entity, the following methods can be provided. First, there is a method of displaying a pointing cursor on a screen and moving the pointing cursor to a desired interaction location by moving a mouse cursor using a direction key on a keyboard or a corresponding key. Second, there is a method of sensing entities, which are displayed on the screen and interact with a user, and immediately moving an interaction location to a closest entity in a relevant direction according to the arrangement of the entities when a direction key on a keyboard or a corresponding key is pressed. In this case, the interaction location may be displayed in the shape of a mouse cursor, or the range of available interacting entities may be displayed along the shape of an edge.

Since the above two methods are complementary to each other, it is impossible for a user to conveniently interact with the interface when only one of the two methods is provided. Therefore, the two methods must be provided together, and how the user can conveniently and alternately use the two methods is a key point. In typical cases, the two methods can be switched using a separate key or menu, but they must be used while frequently alternating with each other at the time of interaction, thus resulting in complication in a current situation.

### DISCLOSURE OF INVENTION

### Technical Problem

Accordingly, an object of the present invention is to provide a display control method and a mobile terminal using the method, which can easily perform the prompt movement of a pointing cursor between entities and the movement of the pointing cursor to an arbitrary location on a screen in a user interface for displaying entities, which interact with a user, on the screen.

### Technical Solution

In order to accomplish the above object, the present invention provides a display control method for a mobile terminal, comprising displaying a user interface and a pointing cursor, when a movement key for moving the pointing cursor is pressed for a period of time greater than a preset period of time, moving an indication location of the pointing cursor to correspond to a manipulation direction of the movement key for the period of time during which the movement key is pressed, and when the movement key is pressed for a period of time equal to or less than the preset period of time, moving the indication location of the pointing cursor to an entity close to the pointing cursor in a manipulation direction of the movement key.

Further, a mobile terminal according to the present invention comprises a display unit configured to display a user interface and a pointing cursor, a movement key configured to move the pointing cursor, and a control unit configured such that, when the movement key is pressed for a period of time greater than a preset period of time, an indication location of the pointing cursor is moved to correspond to a manipulation direction of the movement key for the period of time during which the movement key is pressed, and such that, when the movement key is pressed for a period of time equal to or less than the preset period of time, the indication location of the pointing cursor is moved to an entity close to the pointing cursor in a manipulation direction of the movement key.

In order to accomplish the above object, the present invention provides a computer-readable recording medium for storing a program for executing the display control method in a computer.

### Advantageous Effects

According to the present invention, the prompt movement of a pointing cursor between entities and the movement of the pointing cursor to an arbitrary location on a screen can be performed using the same movement key in a user interface for displaying entities, which interact with the user, on the screen. Accordingly, the user adjusts the time for which the user presses and removes pressure from the movement key, thus conveniently and easily moving an interaction location through a desired method, compared to the case where movement methods are switched using different keys or menus.

### BRIEF DESCRIPTION OF THE DRAWINGS

FIG. 1 is a diagram showing an example of the construction of a mobile terminal to which a display control method according to an embodiment of the present invention is applied;

FIG. 2 is a flowchart showing a display control method according to an embodiment of the present invention; and

FIGS. 3 and 4 are reference diagrams showing a display control method according to an embodiment of the present invention, together with a screen displayed on a mobile terminal.

### DESCRIPTION OF REFERENCE NUMERALS OF PRINCIPAL ELEMENTS IN THE DRAWINGS

11: wireless communication unit 12: key input unit

13: display unit 14: interface unit

15: sound processing unit 16: memory

17: control unit

### BEST MODE FOR CARRYING OUT THE INVENTION

Hereinafter, embodiments of the present invention will be described in detail with reference to the attached drawings.

A display control method according to the present invention allows a user to conveniently switch and use a method of displaying a pointing cursor on a screen and moving the pointing cursor to a desired interaction location by manipulating the pointing cursor using a direction key or a corresponding key, and a method of sensing entities, which are displayed on the screen and interact with the user, and directly moving an interaction location to a closest entity in the manipulation direction of a direction key or a corresponding key according to the arrangement of the entities by manipulating the direction key or the corresponding key.

Further, the display control method according to the present invention may be applied to mobile terminals. The mobile terminals described in the present specification may include a mobile phone, a smart phone, a notebook computer, a digital broadcasting terminal, a Personal Digital Assistant (PDA), a Portable Multimedia Player (PMP), a navigation terminal, etc.

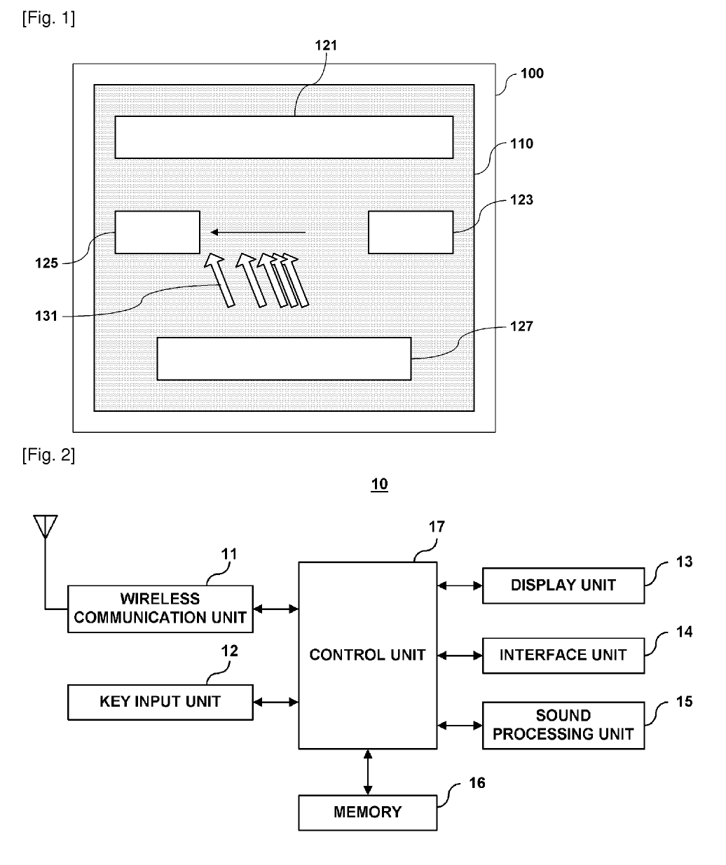

FIG. 1 is a diagram showing an example of the construction of a mobile terminal to which the display control method of the present invention is applied. Referring to FIG. 1, a mobile terminal 10 includes a wireless communication unit 11, a key input unit 12, a display unit 13, an interface unit 14, a sound processing unit 15, memory 16, and a control unit 17.

The wireless communication unit 11 provides interfaces for broadcast reception, mobile communication, wireless Internet, short-range communication, etc. The key input unit 12 is provided with a plurality of keys including a direction key or the like, and is configured to transmit a signal corresponding to the key pressed by the user to the control unit 17 and receive an operation command or data from the user. The display unit 13 is implemented using a Liquid Crystal Display (LCD), and is configured to display a user interface including menus for operational control and to display signal reception status information, battery information, and information about the operating status of the mobile terminal corresponding to a command received from the user.

The interface unit 14 functions as an interface with all external devices connected to the mobile terminal 10. Examples of external devices connected to the mobile terminal 10 include wired/wireless headsets, an external charger, wired/wireless data ports, a memory card, card sockets, such as SIM/UIM cards, an audio Input/Output (I/O) terminal, a video I/O terminal, an earphone, etc.

The sound processing unit 15 amplifies a sound signal output from the control unit 17 and outputs the amplified sound signal to a speaker or the like, or converts a sound signal input through a microphone or the like into an electrical signal and transmits the electrical sound signal to the control unit 17. The memory 16 stores programs or data required for the operation of the mobile terminal, or various types of data intended by the user to be stored.

The control unit 17 controls the entire operation of the mobile terminal by controlling the operations of respective components. In particular, when a movement key for moving the pointing cursor, such as a direction key, is pressed for a period of time greater than a preset period of time, the control unit 17 moves the indication location of the pointing cursor to correspond to the manipulation direction of the movement key for the period of time during which the movement key is pressed. Further, the control unit 17 performs control so that, when the movement key is pressed for a period of time equal to or less than the preset period of time, the indication location of the pointing cursor is moved to an entity close to the pointing cursor in the manipulation direction of the movement key.

FIG. 2 is a flowchart showing a display control method according to an embodiment of the present invention. Referring to FIG. 2, the control unit 17 performs control such that, when a specific menu is manipulated or when a specific key is pressed in a standby mode, both the user interface and the pointing cursor are displayed on the screen of the display unit 13 at step S20. The pointing cursor displayed on the screen is visually moved along with the manipulation of a key, designated as the movement key of the pointing cursor, for example, a direction key. Typically, the shape of the pointing cursor is arrow-shaped, but may be changed to a shape desired by the user and then displayed. Further, the movement key of the pointing cursor may be implemented using a joystick, a touch pad, a trackball, a pointing stick, a finger mouse, etc.

The control unit 17 performs different control operations depending on the times for which the pointing cursor movement key, designated to move the pointing cursor, is pressed when the pointing cursor movement key is pressed. That is, when the pointing cursor movement key is pressed for a period of time greater than a preset period of time, the control unit 17 performs control such that the pointing cursor is moved and displayed to correspond to the manipulation direction of the pointing cursor movement key at steps S30 and S35. However, when the pointing cursor movement key is pressed for a period of time equal to or less than the preset period of time, the control unit 17 performs control such that the pointing cursor is moved to an entity, such as a menu item or a selection item that is close to the pointing cursor in the manipulation direction of the pointing cursor movement key at steps S30 and S40.

Further, when, at step S25, a key other than the pointing cursor movement key is pressed at step S45, the control unit 17 performs control such that an operation corresponding to the pressed key is performed at step S50. Examples of the press of keys other than the pointing cursor movement key include the press of keys for a text input operation, other menu switching operations, or communication functions.

Through the above process, when the user presses the key which is designated as the pointing cursor movement key, and then removes pressure from the key within a predetermined period of time, the current interaction location is immediately moved to an entity closest to the pointing cursor in the direction designated by the key. In contrast, when the user presses the key which is designated as the pointing cursor movement key, and does not remove pressure from the key within the preset predetermined of time, the current interaction direction is gradually moved in the direction designated by the key, regardless of the locations of entities, using a method similar to a method of moving the pointing cursor. The movement of the interaction location is stopped when the user removes pressure from the key. In order to move the interaction location to an arbitrary place, since the period during which the key is pressed is inevitably lengthened due to limitations on the speed of the cursor, a method of moving the interaction location to the arbitrary place by pressing the key for a long period of time may be naturally acceptable.

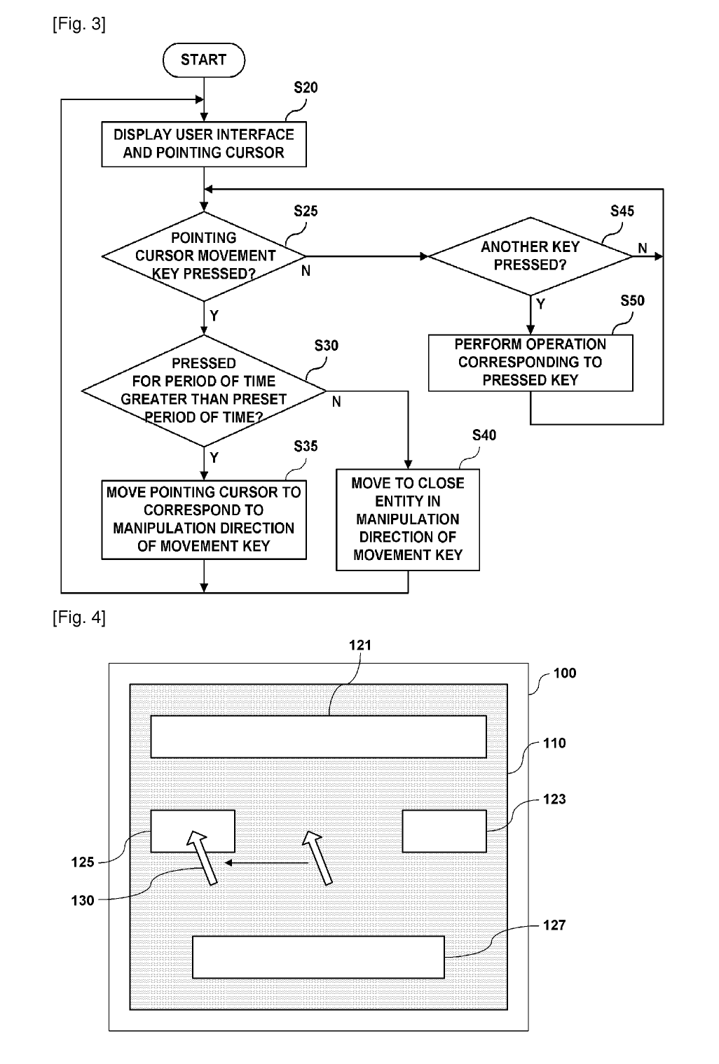

FIGS. 3 and 4 are reference diagrams showing a display control method for a mobile terminal according to an embodiment of the present invention, together with a screen displayed on the display unit.

First, FIG. 3 shows that a user interface 110 is displayed on the screen 100 of the display unit 13, and entities 121, 123, 125 and 127, such as menu items or selection items, are displayed in the user interface 110. Further, on the screen 100, an arrow-shaped pointing cursor 130 is displayed. The pointing cursor 130 indicates the location at which the user can currently interact with a corresponding entity. FIG. 3 illustrates a method in which the pointing cursor 130 is moved to an entity close to the pointing cursor depending on the manipulation direction of the movement key, and thus an interaction location with the user is immediately moved. Further, FIG. 4 illustrates a method in which a pointing cursor 131, indicating the interaction location, is gradually moved in the direction in which the movement key is pressed, regardless of the location of the entities.

Through the above process, the prompt movement of the pointing cursor between the entities and the movement of the pointing cursor to the arbitrary location on the screen can be easily performed in the user interface for displaying entities, which interact with the user, on the screen.

Further, in the above embodiment, although the pointing cursor has been described as an example, this is only an example, and the present invention is not limited to this example, and can be applied to all shapes or displays indicating locations which enable interaction with the user on a screen.

Meanwhile, the present invention can be implemented as processor-readable code in recording media readable by a processor provided in the mobile terminal. The processor-readable recording media include all types of recording devices in which processor-readable data may be stored. Examples of the processor-readable recording media include Read Only Memory (ROM), Random Access Memory (RAM), a Compact Disc (CD)-ROM, magnetic tape, a floppy disc, an optical data storage device, etc., and also include a medium realized in the form of a carrier wave, for example, transmission performed over the Internet. Further, the processor-readable recording media may be distributed to computer systems connected through a network and processor-readable code may be stored and executed in the computer systems in a distributed manner.

Further, in the present specification, although the preferred embodiments of the present invention have been shown and described, the present invention is not limited to the above-described specific embodiments, those skilled in the art will appreciate that various modifications are possible in the art, without departing from the gist of the invention as disclosed in the accompanying claims, and such modifications should not be understood separately from the technical spirit or scope of the present invention.

1. A display control method for a mobile terminal, comprising:
displaying a user interface and a pointing cursor;
if a movement key for moving the pointing cursor is pressed for a period of time greater than a preset period of time, moving an indication location of the pointing cursor to correspond to a manipulation direction of the movement key for the period of time during which the movement key is pressed; and
if the movement key is pressed for a period of time equal to or less than the preset period of time, moving the indication location of the pointing cursor to an entity close to the pointing cursor in a manipulation direction of the movement key.

2. The display control method according to claim 1, wherein, when the indication location of the pointing cursor is moved to the close entity, display is performed such that a movement track of the pointing cursor appears.

3. The display control method according to claim 1, wherein the entity includes a menu item and a selection item.

4. A mobile terminal, comprising:
a display unit configured to display a user interface and a pointing cursor;
a movement key configured to move the pointing cursor; and
a control unit configured such that, when the movement key is pressed for a period of time greater than a preset period of time, an indication location of the pointing cursor is moved to correspond to a manipulation direction of the movement key for the period of time during which the movement key is pressed, and such that, when the movement key is pressed for a period of time equal to or less than the preset period of time, the indication location of the pointing cursor is moved to an entity close to the pointing cursor in a manipulation direction of the movement key.

5. The mobile terminal according to claim 4, wherein the control unit performs display such that, if the indication location of the pointing cursor is moved to the close entity, a movement track of the pointing cursor appears.

6. The mobile terminal according to claim 4, wherein the movement key is one of a joystick, a touch pad, a trackball, a pointing stick, a finger mouse, and a direction key.

7. A processor-readable recording medium for storing a program for executing the display control method for the mobile terminal according to claim 1 in a processor.

8. A processor-readable recording medium for storing a program for executing the display control method for the mobile terminal according to claim 2 in a processor.

9. A processor-readable recording medium for storing a program for executing the display control method for the mobile terminal according to claim 3 in a processor.
